(19) United States
(12) Patent Application Publication
(10) Pub. No.: US 2008/0289665 A1
(43) Pub. Date: Nov. 27, 2008

(54) Apparatus for Cleaning a Refuse Bin

(76) Inventor: Martin John Dwyer, Queensland (AU)

Correspondence Address: YOUNG & THOMPSON, 209 Madison Street, Suite 500, ALEXANDRIA, VA, 22314, US

(21) Appl. No.: 11/631,148

(22) PCT Filed: Jul. 1, 2005
(86) PCT No.: PCT/AU05/00969

§ 371 Date: Dec. 29, 2006

(30) Foreign Application Priority Data
Jul. 1, 2004 (AU) 2004903573

(51) Int. Cl. B08B 13/00; B65G 65/34

(52) U.S. Cl. 134/104.4; 134/104.2; 414/422

(57) ABSTRACT

Provided is an apparatus (10) for cleaning emptied refuse bins. The apparatus has a platform (14) supporting a reservoir (18) containing a cleaning fluid, a bin cleaning station (20), a pumping arrangement (22) for causing the cleaning fluid in the reservoir to flow through tubes (24 and 26) to a spray device (28) in the cleaning station, and a lifting device (16) arranged to lift and invert a refuse bin (60) to be cleaned over a chute (82). The spray device has a rotating spray head (88) with spray nozzles (98, 100) controllably positionable within the chute for cleaning the side walls of the bin. Other spray nozzles (104, 106) are used to clean the lid (84) of the bin. The chute has a slanting base (108) with a drain outlet (110) arranged for the sprayed cleaning fluid flowing off the bin and the any fluid that misses the bin to flow towards the outlet. A filter arrangement (112) filters the sprayed fluid from the outlet before entering into a sump (114).

### TECHNICAL FIELD OF THE INVENTION

THIS INVENTION relates generally to an apparatus for cleaning a refuse bin, and in particular but not limited thereto, the apparatus includes a vehicle having a lifting device for lifting and inverting said refuse bin, a spray arrangement for spraying a cleaning fluid onto the refuse bin, and a chute arrange to collect the fluid from the refuse bin for recycling thereof.

### BACKGROUND OF THE INVENTION

Refuse bins are generally used to hold refuse such as household and industrial waste materials until the materials are emptied by waste management agencies. Usually, the waste materials include decomposable materials which will progressively decompose and emit foul odour. The decomposing materials also attract disease carrying insects such as flies, mosquitoes, cockroaches, etc., and scavenging animals such as rats, etc.

Some of the waste materials including the decomposing materials will remain in the bins after emptying, as emptying of bins do not always dispose of the materials sticking to sides and bottom of the bins. Some proportions of fluids amongst the waste materials will also remain in the bins. Accordingly, after emptying, the bins continue to have foul odour and remain attractive to the disease carrying insects and scavenging animals.

Many people resort to clean their refuse bins with water after each emptying. Brushing may also be required to remove the materials sticking to the side walls and bottom of the bins. The water used in the cleaning process will seep into the ground and/or allow to flow into the drainage system. A large volume of water is thus consumed in the cleaning process. If any of the waste materials remaining in the bins are poisonous the bin cleaning process will contaminate the ground and/or the drainage system and/or water system.

Current manual cleaning methods severely limit the number of containers able to be sanitised or cleaned in one working period due to the high level of manual labour required and the necessity to always leave the vehicle to effect cleaning.

### OBJECT OF THE PRESENT INVENTION

An object of the present invention is to alleviate or to reduce to a certain level one or more of the above prior art disadvantages.

### Outline of the Present Invention

In one aspect therefore the present invention resides in an apparatus for cleaning a refuse bin. The apparatus includes a chute having side walls surrounding an interior space, an open top and a base having an outlet; a spraying device arranged to spray a cleaning fluid into a refuse bin which is in an inverted position and supported over the open top; and a sump arranged to retain the cleaning fluid flowing through the outlet.

In preference, said base is arranged in a slant and has a relatively higher edge and a relatively lower edge, and the outlet is positioned at or adjacent to the lower edge.

It is preferred that the spraying device has at least one first spray means arranged to spray into the refuse bin. The at least one first spray means may include a rotatable spray head having one or more nozzles arranged to spray the cleaning fluid into the refuse bin. The spray head may have means arranged to cause rotation of the spray head so as to increase the efficiency of the cleaning action. Such rotation means may be in the form of offset nozzles or a mechanical or hydraulic or pneumatic rotary head. The offset nozzles may have at least one pair of nozzles which are oriented oppositely so that streams of the cleaning fluid flowing through the oppositely oriented nozzles cause the head to rotate.

The spray head is preferably mounted on an extensible member arranged to move between an extended position where the spray head is substantially within the refuse bin and a retracted position where the spray head is outside the refuse bin. The extensible member may be in the form of a hydraulic or pneumatic ram.

The refuse bin may have a body configured with a refuse holding chamber and a lid hingedly connected to the body for positioning between a closed position for closing the chamber and an open position for depositing refuse into or emptying refuse from the chamber. The spray device may have second spray means arranged to spray the cleaning fluid onto the lid in the open position. Preferably, the second spray means is arranged to spray the cleaning fluid onto both sides of the lid.

The refuse bin may have a peripheral flange where the lid rests in its closed position, and the spray device may have third spray means arranged to spray the cleaning fluid at the peripheral flange.

The spray device may also have fourth spray means arranged to spray the exterior of the body of the refuse bin.

Typically, at least one of the second, third and fourth spraying means is arranged on the side walls of the chute.

Advantageously, the apparatus includes a filter arrangement arranged to filter the sprayed cleaning fluid flowing from the outlet so that the fluid entering the sump is substantially free of solid materials. The filter arrangement may have one or more layers of mesh materials arranged in the path of flow of the sprayed cleaning fluid from the outlet to the sump. Preferably, the layers of the mesh materials are arranged from a relatively coarse mesh to a relatively fine mesh in the direction of flow of the sprayed cleaning fluid.

Advantageously, the chute of the apparatus may include a relatively coarse mesh filter (about 5 mm to 50 mm) situated above the base of the chute in order to capture any larger waste materials released from the bin by the cleaning process. An access door may be arranged to facilitate clearance of any larger waste materials captured at the relatively coarse mesh filter.

The apparatus may have a reservoir arranged to hold the cleaning fluid and first pump means arranged to cause the cleaning fluid in the reservoir to flow under pressure to the spray device. The apparatus may also have second pump means arranged to cause the sprayed cleaning fluid in the sump to flow into the reservoir. Typically, the second pump means is arranged to cause the sprayed or used cleaning fluid collected via the flow path through the chute and the filter arrangement into the sump to flow to the holding reservoir. Filtering means may also be arranged in the flow path from the sump to the reservoir.

The refuse bin may have a partition wall dividing the bin chamber into a first chamber portion and a second chamber portion, and the spraying device has two of said at least one first spray means, each being arranged to extend into and retract from one of the first and second chamber portions.

The apparatus may be arranged to clean refuse bins of different sizes and/or shapes. In one form, the spraying device has multiples of any of the first, and/or second, and/or third, and/or fourth spray means, each being arranged to facilitate cleaning the internal and/or external surfaces of a refuse bin.

In another aspect therefore the present invention resides in a vehicle including a platform arranged to support thereon the apparatus as hereinbefore described and a lifting device arranged to lift a refuse bin from ground and invert the refuse bin in a position over the chute. The vehicle may be a trailer.

### BRIEF DESCRIPTION OF THE DRAWINGS

In order that the present invention can be more readily understood and be put into practical effect reference will now be made to the accompanying drawings which illustrate non-limiting embodiments of the present invention and wherein:—

FIG. 1 is a top plan view of an embodiment of the apparatus according to the present invention;

FIG. 2 is a partial end view of the apparatus shown in FIG. 1;

FIGS. 3 and 4 show in detail the spray device for the apparatus shown in FIG. 1;

FIG. 5 is a plan view of the spray head of the apparatus shown in FIGS. 3 and 4;

FIG. 6 is a side view of the spray head shown in FIG. 5;

FIG. 7 shows details of the sump and filter arrangement of the apparatus shown in FIG. 2; and

FIG. 8 is a partial section view of another embodiment the apparatus according to the present invention.

### DETAILED DESCRIPTION OF THE INVENTION

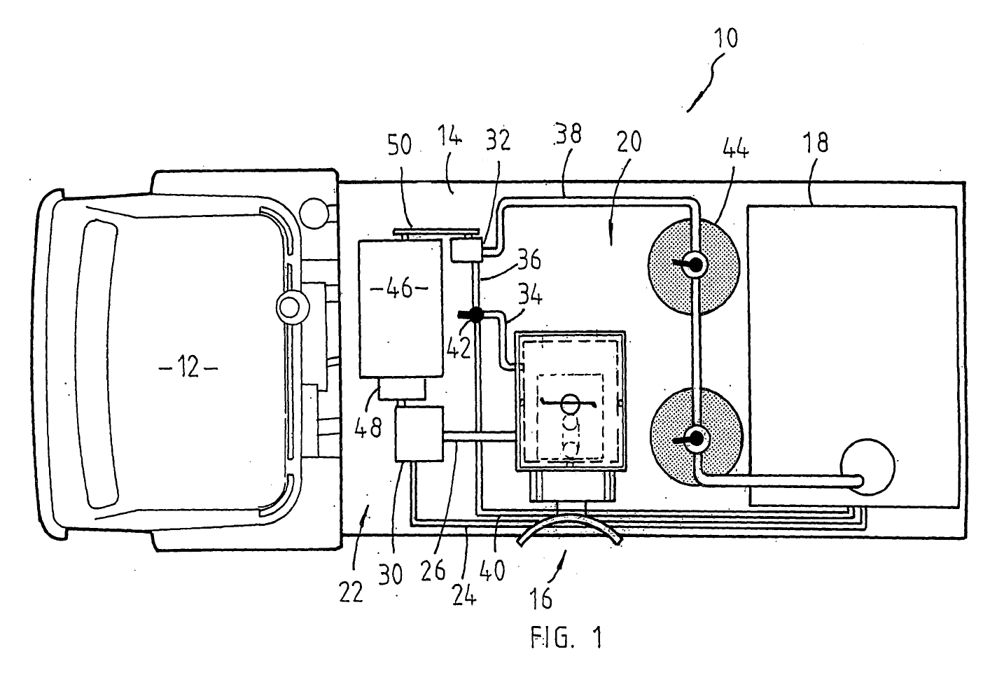

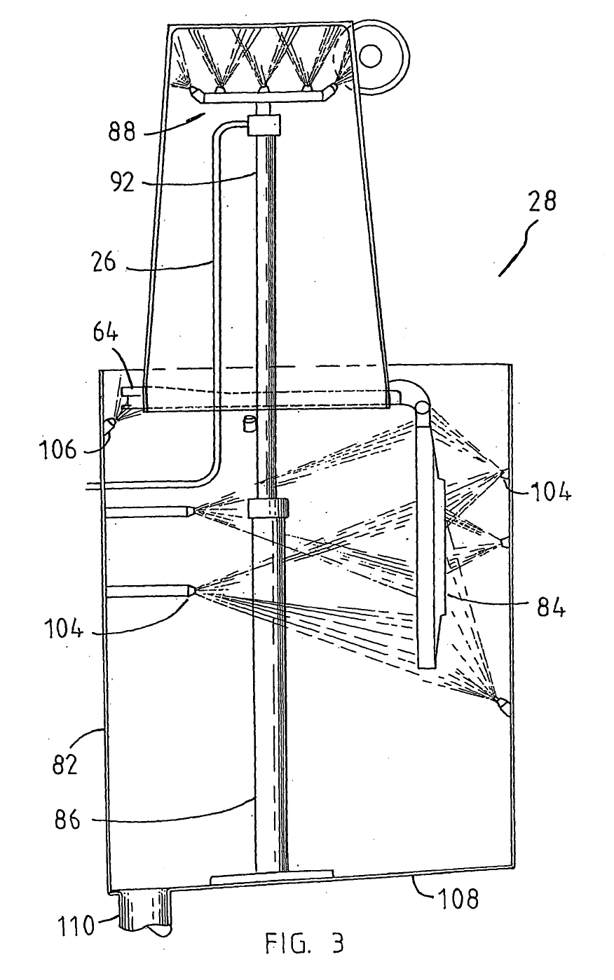

Referring initially to FIG. 1 there is shown an apparatus 10 according to an embodiment of the present invention. The apparatus 10 in this embodiment is in the form of a vehicle having a cab 12 and a platform 14. A lifting device 16 is arranged adjacent to one side of the platform 14. Also arranged on the platform 14 are a reservoir 18 containing a cleaning fluid, a bin cleaning station 20 where a refuse bin lifted and inverted by the lifting device 16 is cleaned. A pumping arrangement 22 is arranged to cause the cleaning fluid in the reservoir 18 to flow through tubes 24 and 26 to a spray device 28 (see FIGS. 3 and 4), and the sprayed fluid to return to the reservoir 18. A first high pressure pump 30 such as a 2200 psi piston pump is used to cause the fluid to flow from the reservoir, and a relatively low pressure pump 32 such as an impeller pump is used to cause the sprayed fluid to return to the reservoir through tubes 34, 36 and 38, or tubes 34 and 40 depending on the position of the valve 42. Note that two sand filters 44 are arranged in the line for the tube 38. A drive unit 46 such as a four cylinder diesel engine is arranged to drive the pump 30 through a reduction gearing 48, and to drive the pump 32 through a pulley arrangement 50.

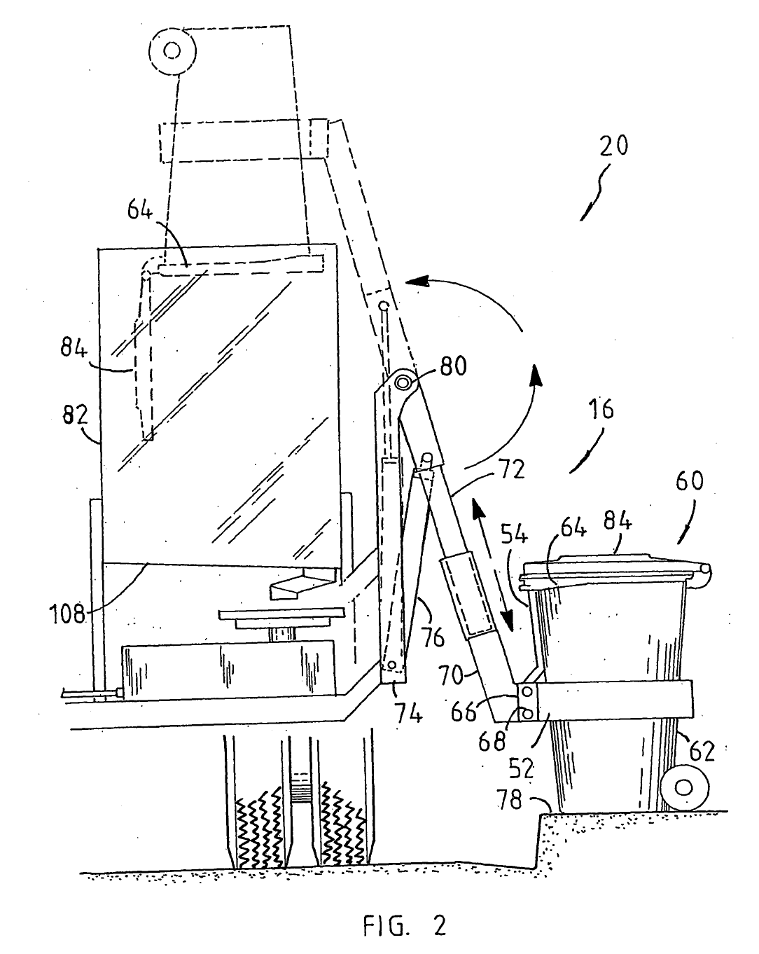

Turning to FIG. 2, the cleaning station 20 as shown has a lifting device 16 which is controllable to move between a down position (shown in solid lines) to an up position (shown in phantom). Usually, control members (not shown) are arranged within the cab 12 so that an operator sitting in the cab12 can control the lifting device 20 and/or the pump without leaving the cab 12.

The lifting device 16 has a pair of lifting jaws 52 (one shown) arranged to receive the body 62 of a refuse bin 60 when the lifting device 16 is in the down position. Extending upwardly from a bar (not shown) interconnecting the jaws 52 is a stop finger 54 which is configured to engage a part of the flange 64 on the body 62. The stop finger 54 ensures that the jaws 52 are in the predetermined lifting position so that when it is inverted operation of the spraying device 28 is not interfered with. The bar is fixed to the jaws 52 by means of channel sections 66 and bolts 68.

Each of the jaws 52 have an angularly and upwardly extending tubular section 70 which is arranged to receive a rod 72. The rod 72 and the tubular section 70 are a telescopically movable relative to each other. In this embodiment the rod 72 has a relatively smaller diameter section and a relatively larger diameter section. The relatively larger diameter section of the rod 72 limits movement of the tubular section 70 as shown in the lifted and inverted position of the bin 60. The larger diameter section of each rod 72 is pivotally fixed to a support bracket 74. A ram 76 is coupled to the rod 72 and is controllable to extend as shown in phantom. When the ram 76 extends the rod 72 moves about a pivotal pin 80. Whereby the bin 60 is lifted off the kerb 78 and moved angularly towards an open top chute 82. When the tubular section and the rod 72 are in a position past horizontal the tubular section 70 moves along the smaller diameter section of the rod 72 until it reaches the larger section. When the ram 76 is fully extended the bin 60 is inverted and in a position above the chute 82 as shown in phantom. In that position the hinged lid 84 of the bin 60 rotates to a fully open position and the flange 64 is just below the top of the chute 82.

A ram 86 within the chute 82 is then controlled to extend to a position a spray head 88 in the bin 60 as shown in FIG. 3. On reaching this position, the high pressure pump 30 operates to draw the cleaning fluid from the reservoir 18 and through the tube 26 to the spray head 88.

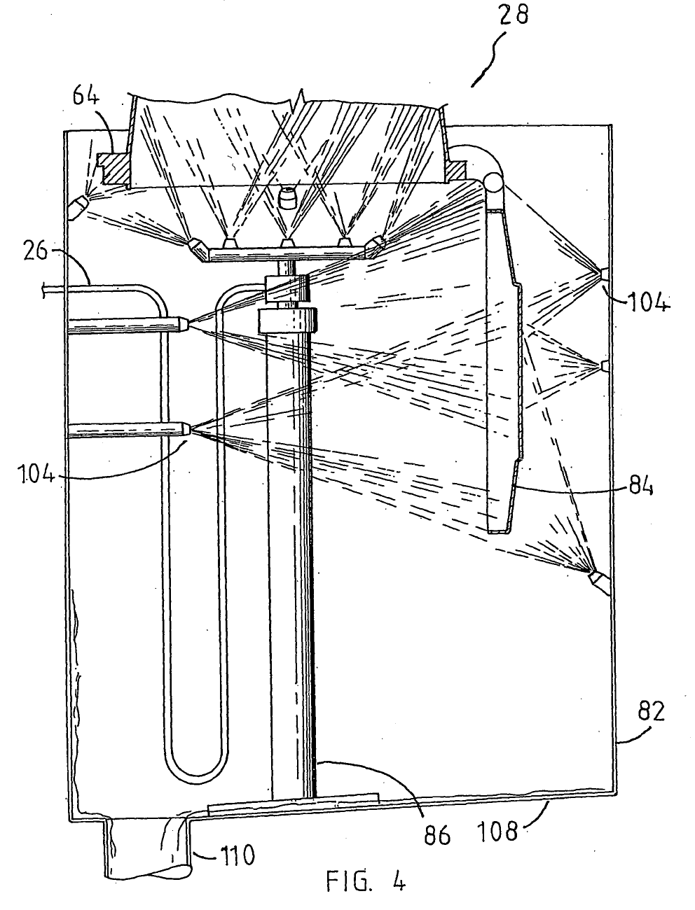

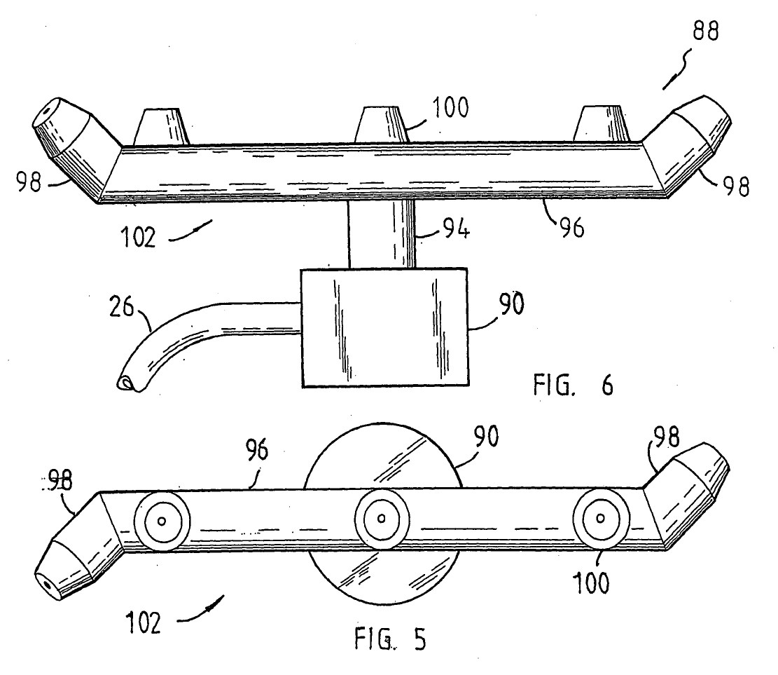

As shown in details in FIGS. 5 and 6, the spray head 88 has a mounting element 90 configured for connection to the hose 26 and for mounting on the piston 92 of the ram 88. Extending from the mounting element 90 is a neck 94 to which a spray element 102 is rotatably mounted. The spray element 102 has a conduit 96, two end nozzles 98 fixed to the ends of the conduit 96 and three intermediate nozzles 100 fixed spacedly to the conduit 96. The two end nozzles 98 are oppositely oriented at about 45° to the conduit 96 so that when the pump 30 forces the cleaning fluid to flow therethrough the spray element 102 rotates about the neck 94. The spray angles of the nozzles 98 and 100 are configured so that the cleaning fluid sprayed thereby reaches substantially the whole interior chamber of the bin 60 when the piston 92 moves progressively to its fully retracted position as shown in FIG. 4.

The cleaning fluid may be simply water, or a disinfectant solution such as that traded under the name of “PHENYLE”. If desired, detergent may be added to water or a disinfectant.

The apparatus also, has nozzles 104 arranged to spray cleaning fluid onto both sides of the lid 84, and nozzles 106 arranged to spray cleaning fluid onto the flange 64.

The chute 82 has a slanting base 108 with a drain outlet 110. The slant of the base 108 causes the cleaning fluid flowing off the bin 60 and the any fluid that misses the bin 60 to flow towards the outlet 110.

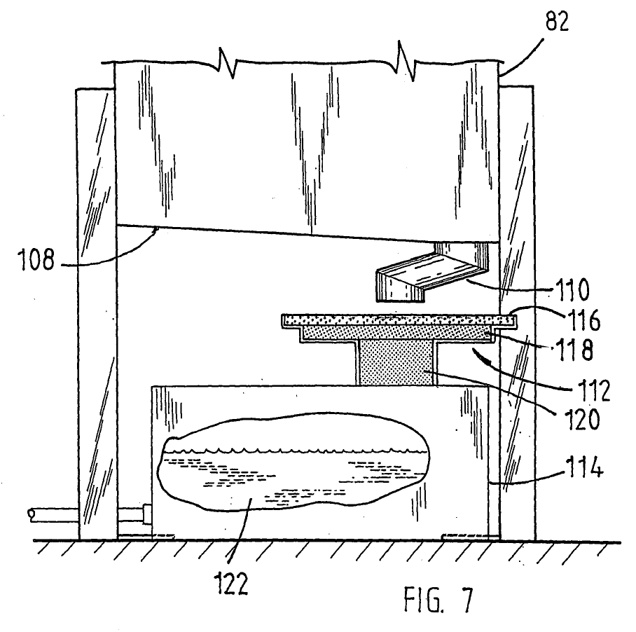

Turning to FIG. 7, as shown the draining outlet 110 is arranged to drain the sprayed fluid through a filter arrangement 112 and into a sump 114. The filter arrangement 112 has three layers of removable filter materials 116, 118 and 120 ranging in screen size from coarse to fine. The cleaning fluid 122 collected in the sump 114 is therefore substantially free of solid particles. The pump 32 can be selectively operated by the operator to cause the fluid 122 to flow through tubes 34 and 40 (see FIG. 1) to return to the reservoir 18. Alternatively the valve can be switched so that the fluid 122 flows through the tubes 34 and 38 and the sand filters 44 before returning to the reservoir 18.

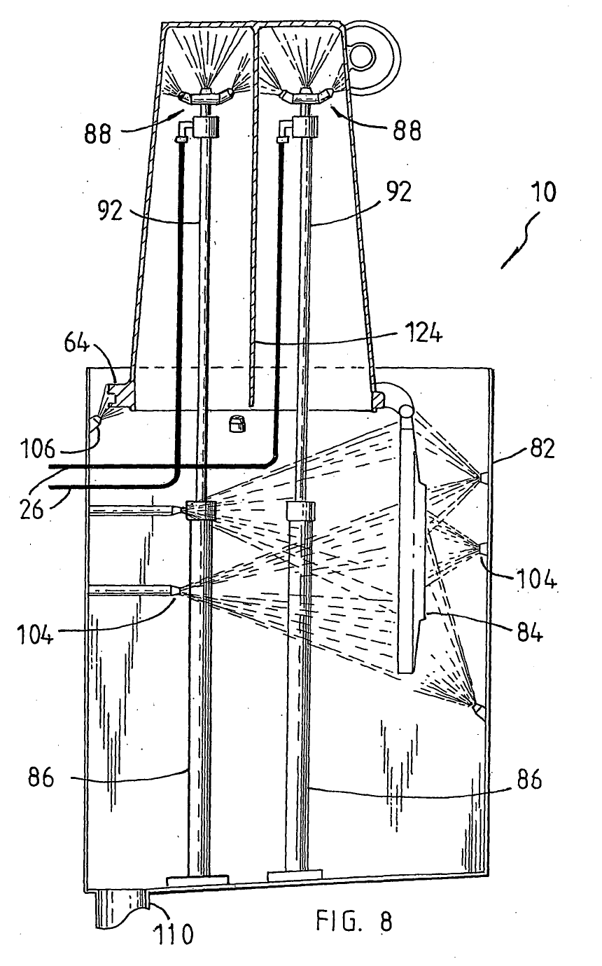

In FIG. 8, there is shown another embodiment of the apparatus 10 according to the present invention. The apparatus 10 of this embodiment is configured for cleaning a split bin 60 having a partition 124 dividing the interior chamber of the bin 60 into sub-chambers. The apparatus 10 as shown has two rams 86 each supporting a spray head 88. The spray heads 88 of this embodiment are shorter than that of the previously described embodiment, and have a single intermediate nozzle. Otherwise, this apparatus is substantially the same as the previously described embodiment.

Accordingly, the cleaning fluid is reused for subsequent bin cleaning and as substantially all sprayed fluid is collected in the chute 82 the environment is not contaminated during cleaning of bins.

Whilst the above has been given by way of illustrative example of the present invention many variations and modifications thereto will be apparent to those skilled in the art without departing from the broad ambit and scope of the invention as herein set forth in the following claims.

1. An apparatus for cleaning a refuse bin, the apparatus including a chute having side walls surrounding an interior space, an open top and a base having an outlet; a spraying device arranged to spray a cleaning fluid into a refuse bin which is in an inverted position and supported over the open top, and a sump arranged to retain the cleaning fluid flowing through the outlet.

2. The apparatus according to claim 1 wherein said base is arranged in a slant and has a relatively higher edge and a relatively lower edge, and the outlet is positioned at or adjacent to the lower edge.

3. The apparatus according to claim 1 wherein the spraying device has at least one first spray means arranged to spray into the refuse bin.

4. The apparatus according to claim 3 wherein the at least one first spray means includes a rotatable spray head having one or more nozzles arranged to spray the cleaning fluid into the refuse bin, and means arranged to cause rotation of the spray head.

5. The apparatus according to claim 4 wherein the rotation means includes an arrangement of the nozzles in an offset manner, and flowing of the cleaning fluid through the offset nozzles causes the spray head to rotate.

6. The apparatus according to claim 4 wherein the offset nozzles having at least one pair of nozzles which are oriented oppositely so that streams of the cleaning fluid flowing through the oppositely oriented nozzles cause the spray head to rotate.

7. The apparatus according to claim 4 wherein the rotation means include a mechanical or hydraulic or pneumatic powered rotor arranged to cause the spray head to rotate.

8. The apparatus according to claim 4 wherein the spray head is mounted on an extensible member arranged to move between an extended position where the spray head is substantially within the refuse bin and a retracted position where the spray head is outside the refuse bin.

9. The apparatus according to claim 8 wherein the extensible member is in the form of a hydraulic or pneumatic ram.

10. The apparatus according to claim 1 wherein the refuse bin having a body configured with a refuse holding chamber and a lid hingedly connected to the body for positioning between a closed position for closing the chamber and an open position for depositing refuse into or emptying refuse from the chamber, and the spray device having second spray means arranged to spray the cleaning fluid onto the lid in the open position.

11. The apparatus according to claim 10 wherein the second spray means is arranged to spray the cleaning fluid onto both sides of the lid.

12. The apparatus according to claim 11 wherein the refuse bin having a peripheral flange where the lid rests in its closed position, and the spray device having third spray means arranged to spray the cleaning fluid at the peripheral flange.

13. The apparatus according to claim 12 wherein the spray device having fourth spray means arranged to spray the exterior of the body of the refuse bin.

14. The apparatus according to claim 13 wherein at least one of the second, third and fourth spraying means is arranged on the side walls of the chute.

15. The apparatus according to claim 1 further including a filter arrangement arranged to filter the sprayed cleaning fluid flowing from the outlet so that the fluid entering the sump is substantially free of solid materials.

16. The apparatus according to claim 15 wherein the filter arrangement having one or more layers of mesh materials arranged in the path of flow of the sprayed cleaning fluid from the outlet to the sump.

17. The apparatus according to claim 16 wherein the layers of the mesh materials are arranged from a relatively coarse mesh to a relatively fine mesh in the direction of flow of the sprayed cleaning fluid.

18. The apparatus according to claim 1 wherein a relatively coarse mesh filter is provided above the base of the chute in order to capture any relatively large waste materials released from the bin, and an access door is arranged to facilitate clearance of the relatively large waste materials captured at the relatively coarse mesh filter.

19. The apparatus according to claim 1, further including a reservoir arranged to hold the cleaning fluid and first pump means arranged to cause the cleaning fluid in the reservoir to flow under pressure to the spray device.

20. The apparatus according to claim 19 wherein second pump means is arranged to cause the sprayed cleaning fluid retained in the sump to flow back into the reservoir.

21. The apparatus according to claim 20 wherein filtering means is arranged in the flow path of the sprayed cleaning fluid from the sump to the reservoir.

22. The apparatus according to claim 3 wherein the refuse bin having a partition wall dividing the bin chamber into a first chamber portion and a second chamber portion, and the spraying device has two of said at least one first spray means, each being arranged to extend into and retract from one of the first and second chamber portions.

23. The apparatus according to claim 1 wherein the spray device having multiple interchangeable spray means arranged so that one or a set of spray means is selectable for cleaning a refuse bin of a particular size 9 and/or shape.

24. An vehicle comprising a platform arranged to support thereon the apparatus as claimed in claim 1, and a lifting device arranged to lift a refuse bin from ground and invert the refuse bin in a position over the chute.

25. The vehicle according to claim 24 further having a cab for accommodating an operator of the apparatus, and control members for controlling operations of the lifting device being located within the cab.
